(19) United States
(12) Patent Application Publication
(10) Pub. No.: US 2012/0050395 A1
(43) Pub. Date: Mar. 1, 2012

(54) LIQUID DISCHARGING APPARATUS

(76) Inventor: Shunji Yamaguchi, Kanagawa (JP)

(21) Appl. No.: 13/212,278

(22) Filed: Aug. 18, 2011

(30) Foreign Application Priority Data
Aug. 25, 2010 (JP) P2010-188555

(51) Int. Cl. B41J 2/165

(52) U.S. Cl. 347/29

(57) ABSTRACT

A liquid discharging apparatus includes a liquid discharging head that has a nozzle surface formed with nozzles discharging liquid; a support member that is provided in a position facing the nozzle surface and supports a medium on which liquid discharged from the nozzles is landed; a frame that is movable along a side of the support member in the state of surrounding the side of the support member; and a sealing member that is supported by the frame and seals the nozzles upon coming into contact with the nozzle surface along with the movement of the frame.

### BACKGROUND

The present disclosure relates to a liquid discharging apparatus.

As a liquid discharging apparatus, for example, an ink jet printer is generally used which discharges ink as liquid to a medium to print an image. Such a liquid discharging apparatus includes a liquid discharging head that has a nozzle surface formed with nozzles which discharge liquid to the medium, and a support member that supports the medium facing the nozzle surface. Moreover, during printing, an image is printed by discharging liquid from the nozzles to the medium supported by the support member.

Incidentally, during standby when liquid is not discharged to the medium, in order to protect the nozzles from garbage, dust, drying or the like, the liquid discharging apparatus seals the nozzles using cap members made of rubber or the like (see, Japanese Unexamined Patent Application Publication No. 2009-190233). In addition, in order to seal the nozzles using the cap members, there is a necessity to form a space where the cap members can be situated between the liquid discharging head and the support member, and the cap members or the support member is moved.

### SUMMARY

However, when the movement mechanisms of the cap members and the support member for sealing the nozzles are provided, the configuration of the apparatus is complicated. Furthermore, in the case of the complicated configuration, there is a problem in that, since there is a necessity to secure the movement time of each member, the time from the printing to the sealing of the nozzles is lengthened, whereby the nozzle surface is not suitably protected.

Thus, it is desirable to provide a newly improved liquid discharging apparatus that is capable of rapidly sealing the nozzles using a simple configuration.

According to an embodiment of the present disclosure, there is provided a liquid discharging apparatus that includes a liquid discharging head that has a nozzle surface formed with nozzles discharging liquid; a support member that is provided in a position facing the nozzle surface and supports a medium on which liquid discharged from the nozzles is landed; a frame that is movable along a side of the support member in the state of surrounding the side of the support member; and a sealing member that is supported by the frame and seals the nozzles upon coming into contact with the nozzle surface along with the movement of the frame.

Furthermore, the plane shape of the sealing member may be a rectangular shape that is formed with a through hole in a center thereof, an inner peripheral portion of a center side of the sealing member is supported by the support member, an outer peripheral portion of an outer periphery side of the sealing member is supported by the frame, and the sealing member may seal the nozzles together with the support member when coming into contact with the nozzle surface.

Furthermore, the outer peripheral portion of the sealing member may be moved along with the movement of the frame, and the outer periphery portion comes into contact with the nozzle surface when the sealing member is situated in the contact position, whereby the sealing member may seal the nozzles.

Furthermore, the sealing member may include a bent portion that has flexibility and connects the inner peripheral portion with the outer peripheral portion, and the outer peripheral portion may be moved along with the movement of the frame while the bent portion is deformed.

Furthermore, the sealing member may have a protrusion that comes into contact with the nozzle surface when being situated in the contact position, and the protrusion may seal the nozzles by coming into contact with the nozzle surface.

Furthermore, the liquid discharging head may be fixedly supported so as not to be movable to an apparatus main body.

According to the present disclosure mentioned above, it is possible to provide a liquid discharging apparatus that is capable of rapidly sealing the nozzles using a simple configuration.

### BRIEF DESCRIPTION OF THE DRAWINGS

FIG. 1 is a block diagram that shows the overall configuration of a printer;

FIG. 2 is a perspective view that shows an inner configuration of a printer;

FIG. 3 is a cross-sectional view that shows an inner configuration of a printer;

FIG. 4 is a perspective view that shows a maintenance unit;

FIG. 5 is a perspective view that shows a platen and a cap unit.

FIG. 6 is a cross-sectional view that views the state, in which a rib 114 seals the nozzles, from the front.

FIG. 7 is a cross-sectional view that views the state, in which a rib seals the nozzles, from the side.

FIG. 8 is an enlarged view of region A of FIG. 6.

FIG. 9 is an enlarged view of region B of FIG. 7.

FIG. 10 is a diagram for describing flexibility of the

FIG. 11 is a diagram that shows a cap unit immediately before sealing nozzles.

FIG. 12 is a diagram that shows the cap unit while the nozzles are sealed.

FIG. 13A is a diagram that shows a state in which nozzles are sealed;

FIG. 13B is a diagram that shows a state in which a maintenance unit descends;

FIG. 13C is a diagram that shows a starting state of the cleaning of a nozzle surface;

FIG. 13D is a diagram that shows an ending state of the cleaning of a nozzle surface;

FIG. 14A is a diagram that shows a standby state in which a cap member comes into contact with a nozzle surface;

FIG. 14B is a diagram that shows a movement state of a transport portion and a cap unit; and

FIG. 14C is a diagram that shows a printing state in which a cap member is retreated.

### DETAILED DESCRIPTION OF EMBODIMENTS

Hereinafter, preferred embodiments of the present disclosure will be described in detail. In addition, in the present specification and the drawings, components having substantially the same function will be denoted by the same reference numerals and the repeated descriptions thereof will be omitted.

In addition, the description will be made in the following order:

### 1. Overview of Liquid Discharging Apparatus

### 2. Configuration of Maintenance Unit

2-1. Detailed Configuration of Cap Unit

2-2. Detailed Configuration of Cleaning Unit

### 3. Operation Example of Cap Unit

### 4. Operation Example of Cleaning Unit

### 5. Effectiveness of Printer According to the Present Embodiment

### 6. Other Embodiments

### 1. Overview of Liquid Discharging Apparatus

In the present embodiment, a color ink jet printer (hereinafter, a printer 10) as an example of a liquid discharging apparatus will be described. The printer 10 of the present embodiment is a printing apparatus that prints an image on a paper S by discharging four color inks of, for example, Y (yellow), M (magenta), C (cyan), and K (black) onto the paper S that is an example of a medium.

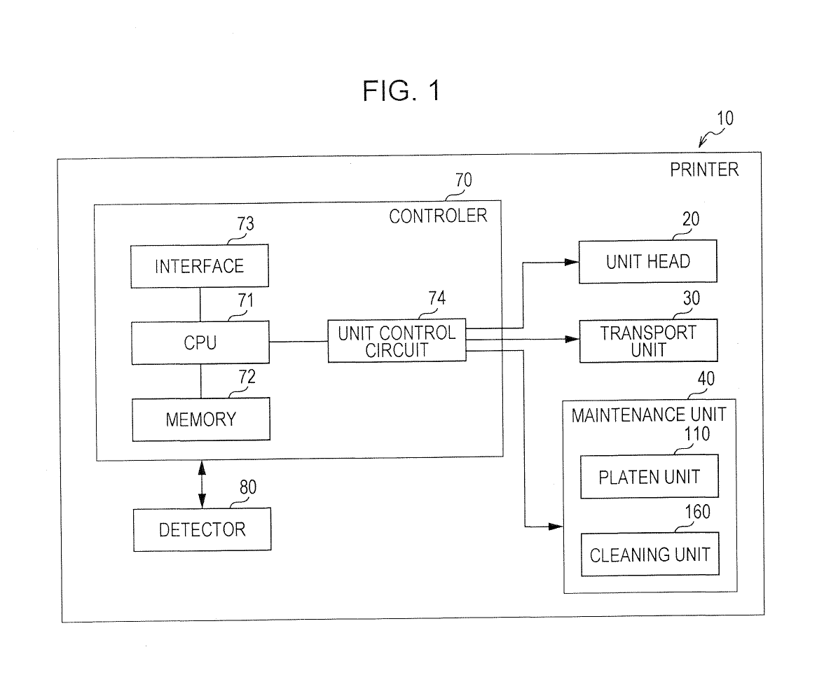

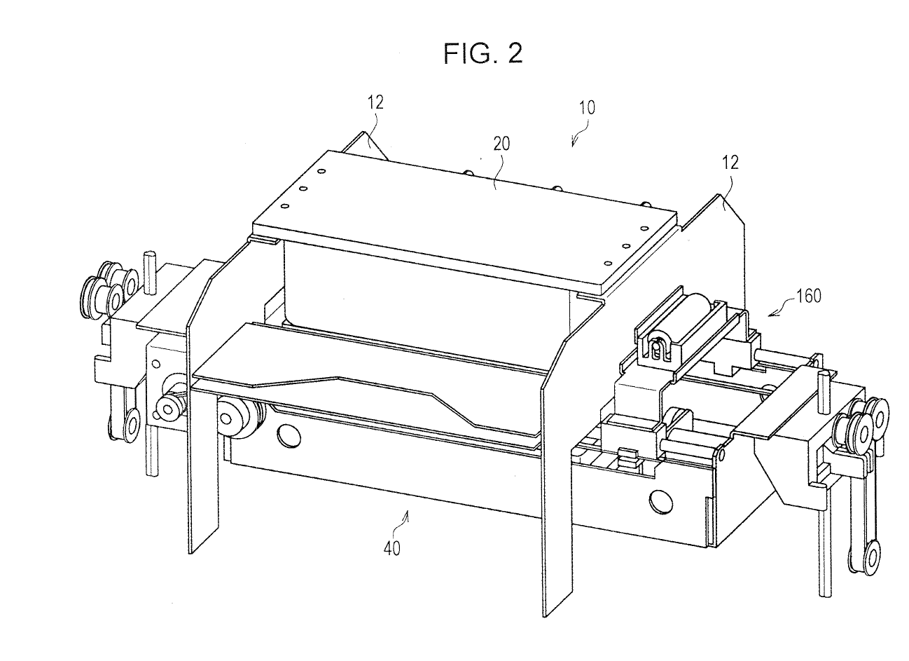

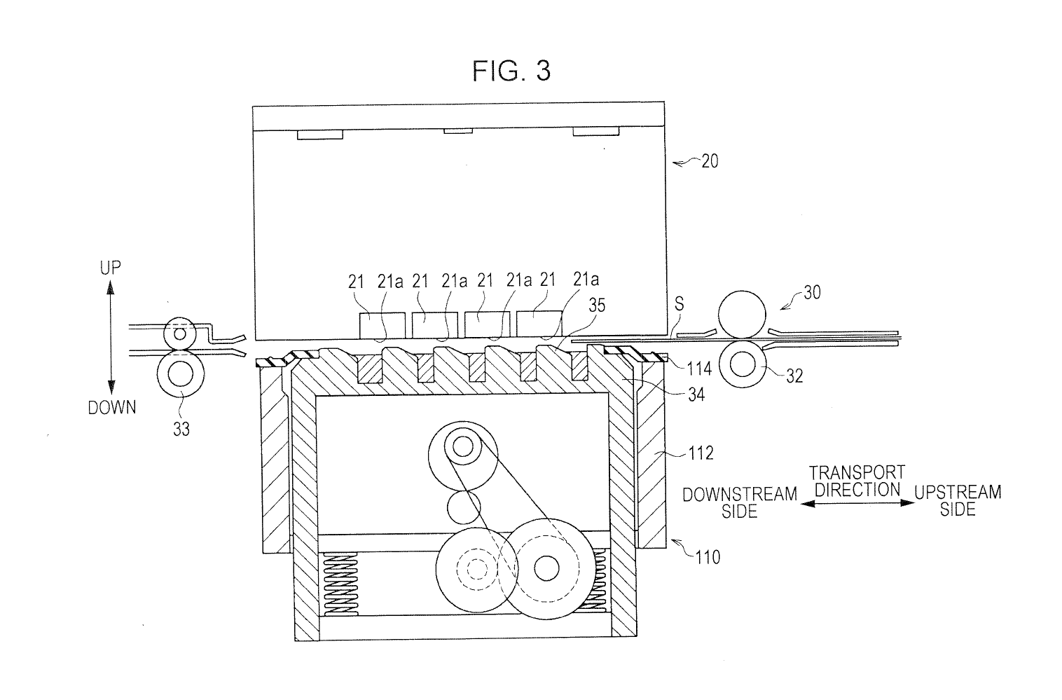

Hereinafter, a configuration example of the printer 10 will be described with reference to FIGS. 1 to 3. FIG. 1 is a block diagram that shows the overall configuration of the printer 10. FIG. 2 is a perspective view that shows an inner configuration of the printer 10. FIG. 3 is a cross-sectional view that shows an inner configuration of the printer 10.

As shown in FIG. 1, the printer 10 has a head unit 20, a transport unit 30, a maintenance unit 40, a controller 70, and a detector 80.

The head unit 20 discharges ink to the paper S so as to print the image on the paper S. As shown in FIG. 2, the head unit 20 is fixed to a pair of main body frames 12 by a screw or the like. That is, while the printer 10 is operated, the head unit 20 is not moved.

Furthermore, as shown in FIG. 3, the head unit 20 has a plurality of line heads 21 provided for each color of ink. The respective line heads 21 are elongated liquid discharging heads having widths longer than that of a paper width of the paper S, and have a nozzle surface 21a formed with nozzles Nz in the lower portion thereof. In each nozzle Nz, an energy generation element (specifically, heating resistor) (not shown) and an ink liquid chamber are provided. Moreover, air bubbles are generated in the ink liquid chamber along with the driving of the heating resistor, and the ink is discharged from each nozzle Nz by energy when the air bubbles are generated.

Moreover, when a region (a printing region where an image is printed) on the paper S passes through immediately below the line head 21, each line head 21 discharges ink from the nozzles Nz. That is, each line head 21 discharges the ink when the nozzle surface 21a faces the paper S. As a result, in the printing region on the paper S, as many dots as the width of the paper are formed at one time.

The transport unit 30 transports the paper S in the transport direction so that the printing region on the paper S passes through immediately below the respective line heads 21. As shown in FIG. 3, the transport unit 30 has an upstream side transport roller 32, a downstream side transport roller 33, and a platen 34 that is an example of a support member.

The upstream side transport roller 32 is a pair of rollers that is situated on the upstream side of the head unit 20 in a transport direction. The downstream side transport roller 33 is a pair of rollers that is situated on the downstream side of the head unit 20 in the transport direction. The upstream side transport roller 32 and the downstream side transport roller 33 are transported in the transport direction in the state of interposing the paper S therebetween.

The platen 34 is a table that is situated between the upstream side transport roller 32 and the downstream side transport roller 33 in the transport direction and supports the paper S to be transported. The platen 34 faces the nozzle surface 21a of the line head 21. The platen 34 has a rib 35, and an ink absorbing material 36. The rib 35 supports the paper S during transportation. The ink absorbing material 36 absorbs ink discharged toward the platen 34.

The maintenance unit 40 performs the maintenance so that the ink discharging from the nozzles Nz is satisfactorily maintained in regard to the respective line heads 21 that are in the resting state (the state of not discharging ink to the paper S). In addition, the detailed configuration of the maintenance unit 40 will be described later.

The controller 70 controls each unit (the head unit 20, the transport unit 30, and the maintenance unit 40). Specifically, the controller 70 controls each unit of the printer 10 by a CPU 71 via a unit control circuit 74 according to a program stored in a memory 72. Furthermore, the controller 70 is able to communicate with a computer (not shown) via an interface 73. Moreover, when receiving printing data from the computer, the controller 70 controls each unit based on the printing data to print the image depending on the printing data on the paper S.

The detector 80 detects the situation in the printer 10. For example, the detector 80 has a paper detection sensor that detects the position of the paper S on the transport path. The detector 80 outputs the signal depending on the detection result toward the controller 70. The controller 70 receives the signal and controls each unit.

Next, the printing processing will be described which prints the color image on the paper S using the printer 10 having the configuration described above. The printing processing is started from that the controller 70 receives the printing data from the computer via the interface 73. The controller 70 interprets the contents of various commands in the received printing data to control each unit of the printer 10. As a result, the transport operation by the transport unit 30 is executed first. That is, the paper S is transported in the transport direction, by the upstream side transport roller 32 or the downstream side transport roller 33.

The controller 70 executes the ink discharging operation by the head unit 20 while executing the transport operation by the transport unit 30. That is, each line head 21 discharges the ink to the printing region on the paper S situated in the opposed position (supported by the platen 34). As a result, as many dots as the paper width of the paper S are formed at one time. As a consequence, the color image is printed on the paper S.

### 2. Configuration of Maintenance Unit 40

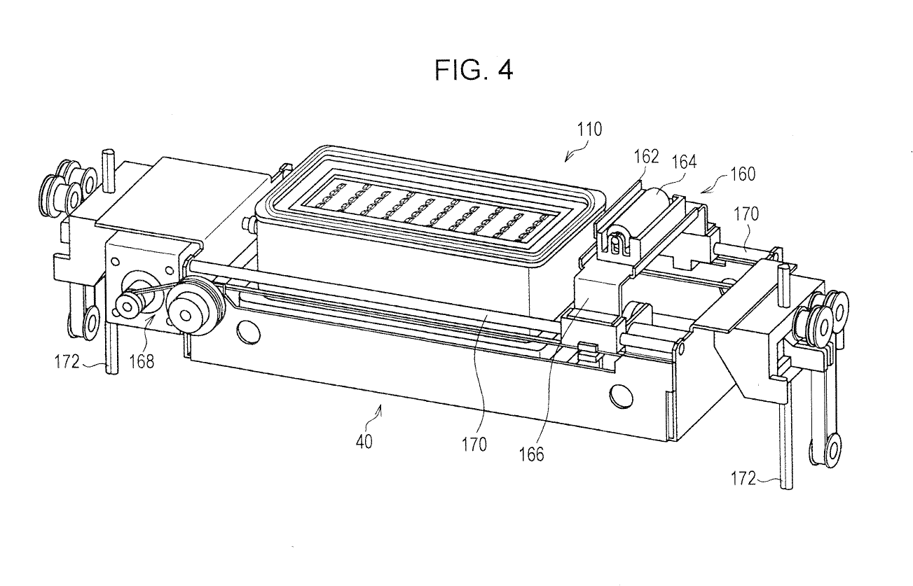

As mentioned above, the maintenance unit performs the maintenance so that the ink discharging from the nozzles Nz is satisfactorily maintained in regard to the respective line heads 21 that is in the resting state (the state of not discharging the ink). The configuration of the maintenance unit 40 will be described using FIG. 4. FIG. 4 is a perspective view that shows the maintenance unit 40.

The maintenance unit 40 has a cap unit 110, and a cleaning unit 160. The cap unit 110 seals the nozzles Nz. The cleaning unit 160 cleans the nozzle surface 21a. In the following, the detailed configuration of the cap unit 110, and the detailed configuration of the cleaning unit 160 will be sequentially described.

### 2-1. Detailed Configuration of Cap Unit 110

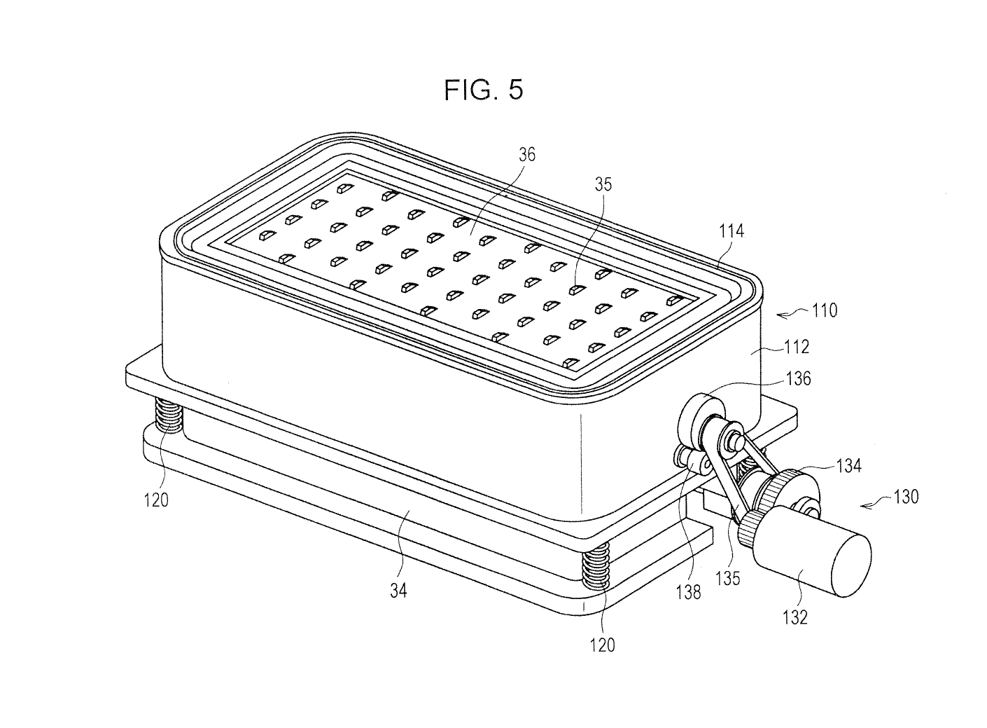

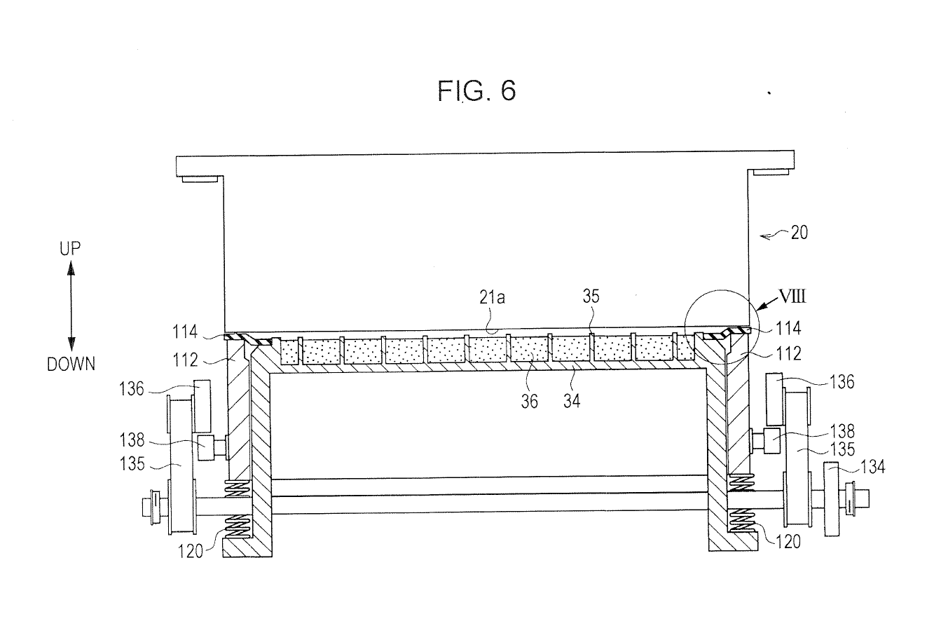

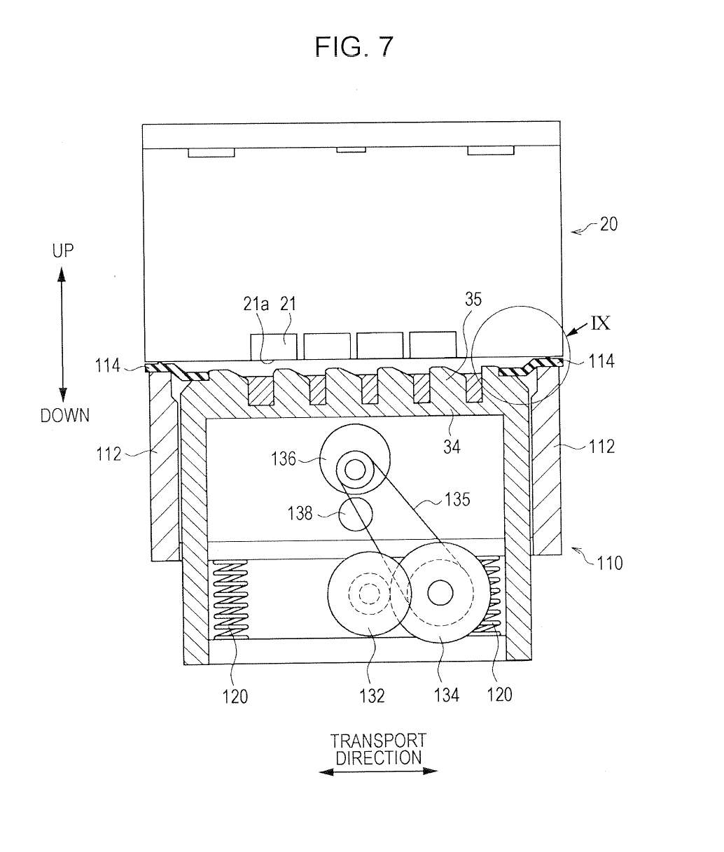

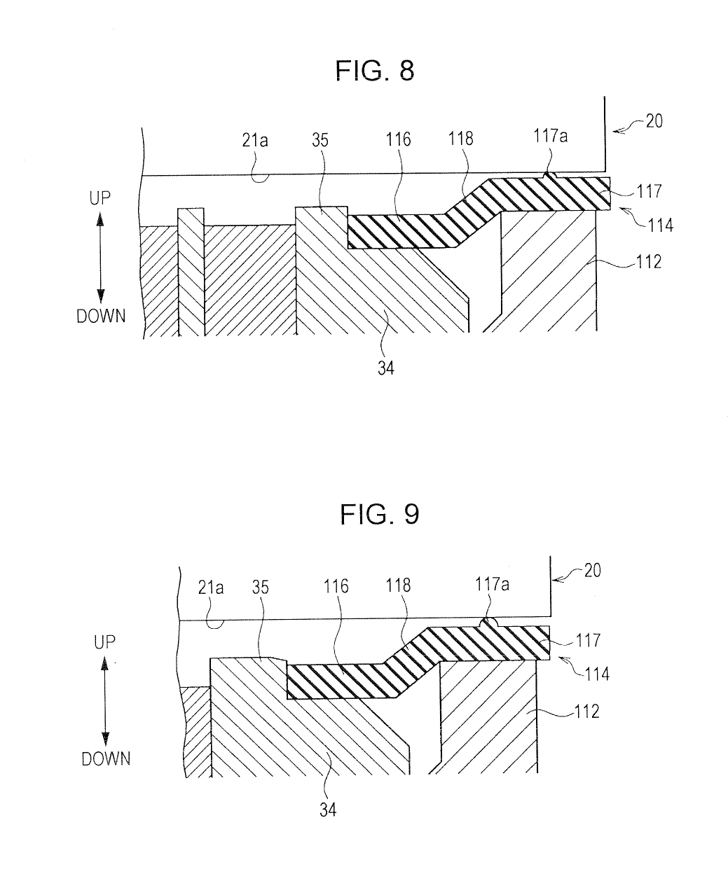

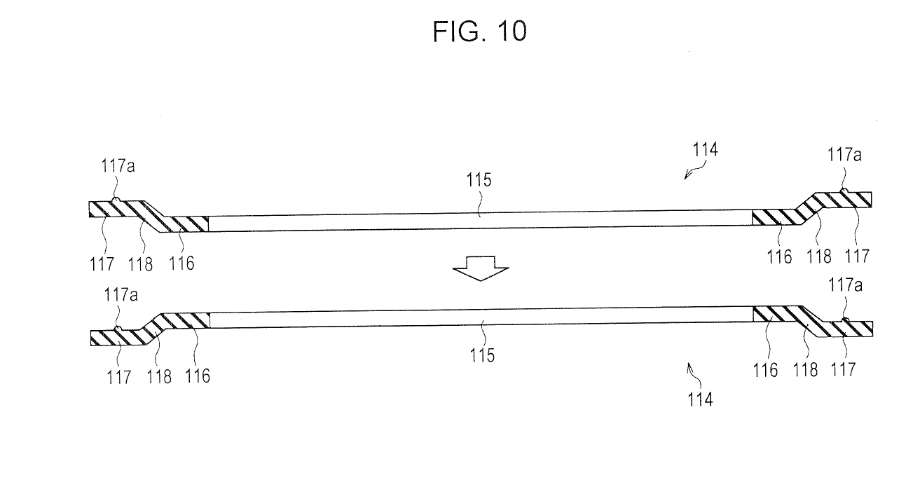

Firstly, the detailed configuration of the cap unit 110 will be described using FIGS. 5 to 10. FIG. 5 is a perspective view that shows the platen 34 and the cap unit 110. FIG. 6 is a cross-sectional view that views the state, in which a rib 114 seals the nozzles, from the front. FIG. 7 is a cross-sectional view that views the state, in which a rib 114 seals the nozzles, from the side. FIG. 8 is an enlarged view of region A of FIG. 6. FIG. 9 is an enlarged view of region B of FIG. 7. FIG. 10 is a diagram for describing flexibility of the rib 114.

The cap unit 110 seals the nozzles Nz. The cap unit 110 according to the present embodiment is provided on the transport path of the paper S as shown in FIG. 3 from the viewpoint of rapidly performing the capping operation. Specifically, the cap unit 110 is provided in the position facing the line head 21 on the transport path. Moreover, the cap unit 110 has a cap frame 112, a rib 114 as an example of the sealing member, a spring 114, a spring 120, and a driving portion 130.

The cap frame 112 is a box-shaped member that surrounds the side of the platen 34. The upper end and the lower end of the cap frame 112 are open ends, and the cap frame 112 is moved to the platen 34 in a vertical direction along the side. Specifically, the cap frame 112 is moved between the cap position (see FIG. 3) and the retreated position (see FIG. 6).

As shown in FIG. 6, the rib 114 seals the nozzles Nz together with the platen 34 when the cap frame 112 is situated in the cap position. The rib 114 has a rectangular shape, and the size of the rib 114 is substantially the same as that of the lower surface (a surface formed with the nozzle surface 21a) of the line head 21. Furthermore, the rib 114 is formed of an elastic member such as rubber.

As shown in FIG. 10, in the center portion of the rib 114, a rectangular hole 115 is formed. The rib 114 is provided in a position where the rectangular hole 115 surrounds the rib 35 of the platen 34. Furthermore, the rib 114 has an inner peripheral portion 116, an outer peripheral portion 117, and a bent portion 118 around the rectangular hole 115.

The inner peripheral portion 116 has a rectangular shape and is situated inside the rib 114. The inner peripheral portion 116 is fixed to a portion of the outer periphery of the rib 35 on the upper surface of the platen 34, for example, by an adhesive. In addition, the inner peripheral portion 116 is fixed in a position lower than the rib 35 of the platen 34 so as to prevent the paper S during transportation coming into contact therewith (see FIG. 3).

The outer peripheral portion 117 has a rectangular shape and is situated outside the rib 114. The outer peripheral portion 117 is fixed to the upper surface 112a of the cap frame 112, for example, by an adhesive. The outer peripheral surface 117 is situated further downwards in the vertical direction than the inner peripheral portion 116 when the cap frame 112 is situated in the retreated position. However, when the cap frame 112 is situated in the cap position, the outer peripheral portion 117 is situated further upwards in the vertical direction than the inner peripheral portion 116.

Furthermore, as shown in FIGS. 8 and 9, in the outer peripheral portion 117, a protrusion 117a as an example of a protrusion portion is formed. The protrusion 117a is formed in a side opposite to the side bonded to the cap frame 112 in the outer peripheral portion 117. The protrusion 117a comes into contact with the nozzle surface 21a during capping. Moreover, the nozzles Nz are sealed by the protrusion 117a of the outer peripheral portion 117. The protrusion 117a comes into contact with the nozzle surface 21a, whereby it is possible to effectively seal the nozzles even in small abutment pressure.

The bent portion 118 is situated between the inner peripheral portion 116 and the outer peripheral portion 117, and connects the inner peripheral portion 116 with the outer peripheral portion 117. The rib 114 is a rubber member that is elastically deformable as mentioned above, and the bent portion 118 is deformed along with the movement of the cap frame 112 as shown in FIG. 10. Thus, the position of the outer periphery portion 117 is moved. As a result, it is possible to move the position of the rib 114 using a simple configuration. Furthermore, by the bent portion 118, it is possible to prevent the rib 114 from being damaged even when the cap frame 112 is repeatedly moved up and down.

In the rib 114 that forms a space together with the platen 34 mentioned above to seal the nozzles, merely by the movement of the outer peripheral portion 117 along with the movement of the cap frame 112, the sealing and unsealing of the nozzles are rapidly performed without moving the platen 34.

As shown in FIG. 5, the spring 120 is a compression spring that is provided between the cap frame 112 and the platen 34. The cap frame 112 is biased to the line head 21 side by the elastic force of the spring 120. In addition, the spring 120 may be, for example, a tension spring, without being limited to the compression spring.

The driving portion 130 moves the cap frame 112 in the vertical direction. As shown in FIG. 5, the driving portion 130 has a motor 132, a gear 134, a belt 135, a cam 136, and a cam follower 138.

The motor 132 is a power source. The gear 134 and the belt 135 transfer the power of the motor 132 by being rotated. The belt 135 connects the gear 134 with the cam 136.

The cam 136 is rotatably attached to a printer main body. Moreover, the cam 136 is rotated in conjunction with the rotation of the gear 134 (the belt 135). The cam 136 is an eccentric cam having an overall eliptical shape.

The cam follower 138 is attached to the cap frame 112 and is moved integrally with the cap frame 112 in the vertical direction. As mentioned above, the cap frame 112 receives the biasing force of the spring 120 and is biased toward the upper side in the vertical direction. For this reason, the cam follower 138 also comes into contact with the outer peripheral surface of the cam 136 by being biased toward the upper side in the vertical direction via the cap frame 112.

Moreover, when the cam 136 is rotated, the cam 136 pushes the cam follower 138 down toward the lower side in the vertical direction to resist the biasing force of the spring 120. When the cam follower 138 is moved to the lower side in the vertical direction, the cap frame 112 is also moved to the lower side in the vertical direction to resist the biasing force of the spring 120. As a consequence, the cap frame 112 is moved to the lower side in the vertical direction with respect to the platen 34 and is situated in the retreated position.

By the cap unit 110 of the configuration mentioned above, it is possible to suppress the solvent evaporation of ink in the vicinity of the opening of the nozzle Nz of the line head 21 when the line head 21 is in the resting state, whereby an occurrence of the clogging is prevented in the nozzle Nz.

In addition, a suction pump (not shown) is connected to the cap unit 120. The suction pump is operated, for example, in the state in which the rib 114 seals the nozzles Nz. As a result, the spaces in the rib 114 and the nozzle surface 21a enter a negative pressure state, whereby the ink in the nozzle Nz is absorbed and forcibly discharged. The line head 21 performing the suction operation can maintain the state of satisfactorily emitting the ink from the nozzles Nz.

### 2-2. Detailed Configuration of Cleaning Unit 160

Next, the detailed configuration of the cleaning unit 160 will be described using FIG. 4 mentioned above.

The cleaning unit 160 cleans the nozzle surface 21a of the line head 21. As shown in FIG. 4, the cleaning unit 160 has a blade 162, a wiper 164, a mover 166, and a driving portion 168.

The blade 162 scrapes the dust or the thickening ink attached to the nozzle surface 21a. The blade 162 is, for example, a rubber blade formed of a rubber material, and comes into contact with the nozzle surface 21a to scrape the dust or the like.

The wiper 164 wipes out the dust or the thickening ink attached to the nozzle surface 21a. The wiper 164 is, for example, a sponge-like porous roller, and comes into contact with the nozzle surface 21a to wipe out the dust or the like.

The mover 166 is moved in the movement direction in the state of holding the blade 162 and the wiper 164. Specifically, the mover 166 is moved in the movement direction along a pair of shaft guides 170. Moreover, the mover 166 is moved in the movement direction in the state in which the blade 162 and the wiper 164 come into contact with the nozzle surface 21a, whereby the nozzle surface 21a is cleaned.

The driving portion 168 moves the mover 166 in the movement direction. The driving portion 168 has a motor as a driving source, a gear or the like.

When the nozzle surface 21a is cleaned by the cleaning unit 160, the maintenance unit 40 descends along the shaft 172 in the vertical direction due to a driving source (not shown) provided in the maintenance unit 40. As a result, a space is formed between the line head 21 and the platen 34 in the vertical direction. When the mover 166 is moved in the formed space, the nozzle surface 21a is cleaned by the blade 162 and the wiper 164. In addition, the cleaning operation of the nozzle surface 21a by the cleaning unit 160 will be described later.

Although the cleaning unit 160 has the blade 162 and the wiper 166 in the embodiment mentioned above, the present disclosure is not limited thereto. For example, the cleaning unit 160 may have any one of the blade 162 and the wiper 166.

### 3. Operation Example of Cap Unit 110

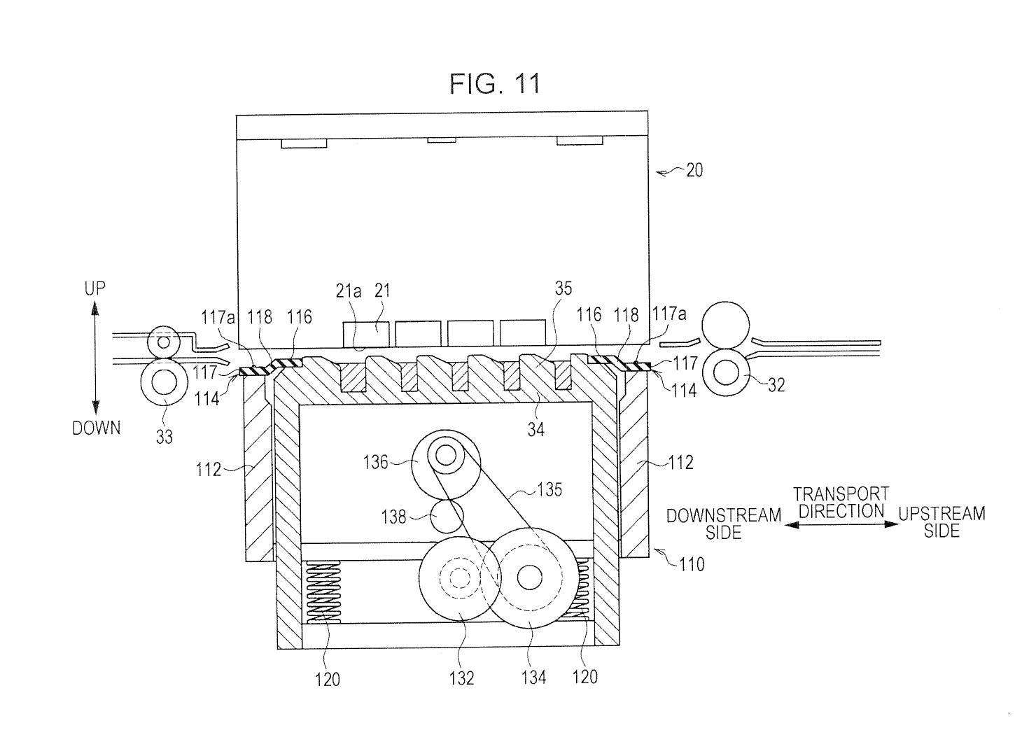

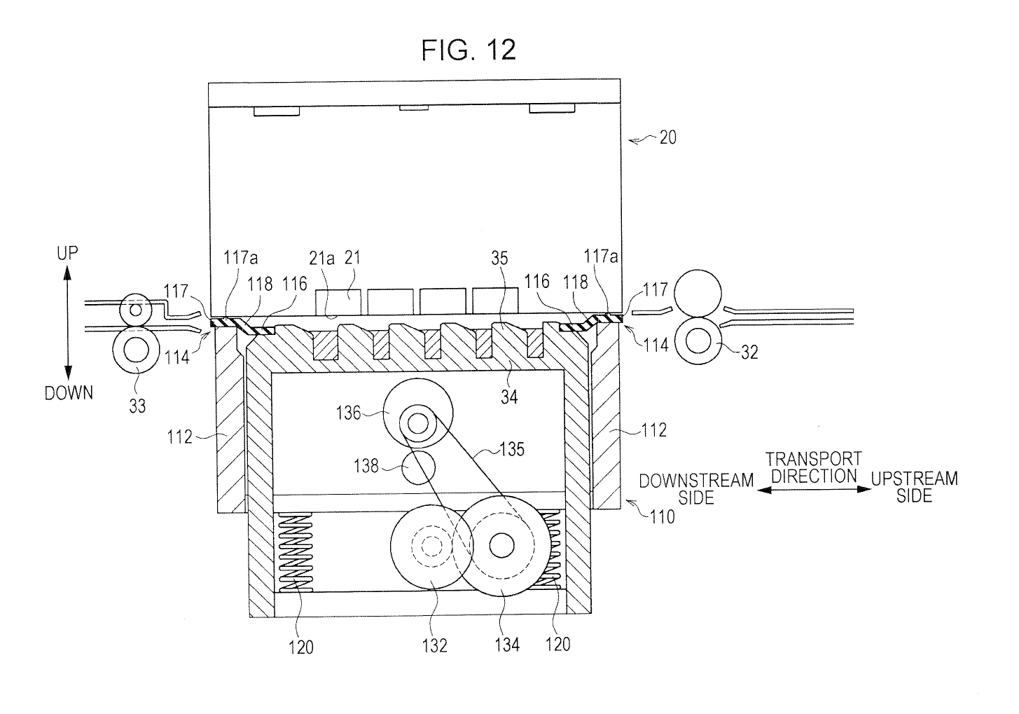

An operation example of the cap unit 110 sealing the nozzles will be described using FIGS. 11 and 12. FIG. 11 is a diagram that shows the cap unit 110 immediately before sealing the nozzles Nz. FIG. 12 is a diagram that shows the cap unit 110 while the nozzles Nz are sealed.

The sealing operation of the nozzles by the cap unit 110 is executed by the controller 70. Moreover, in the present embodiment, the sealing of the nozzles Nz by the rib 114 is consecutively executed when the printer 10 is in the resting state (state in which the ink is not discharged onto the paper S). This is to protect the nozzles Nz formed on the nozzle surface 21a from dust for the drying.

Firstly, an operation example of the cap unit 110 upon sealing the nozzles Nz immediately after the image printing onto the paper S will be described.

When the image is printed on the paper S, specifically, the paper S is transported on the platen 34, as shown in FIG. 11, the cap frame 112 is situated in the retreated position. That is, the outer peripheral portion 117 of the rib 114 is situated in the lower portion further than the rib 35 and the platen 34. At this time, the cam 136 of the cap unit 110 pushes the cam follower 138 down to the lower side in the vertical direction.

Moreover, when the paper S is situated on the downstream side from the line head 21 in the transport direction, the cap unit 110 starts the operation and seals the nozzles Nz. That is, the cam 136 is rotated along with the driving of the driving portion 130, whereby the cam follower 138 and the cap frame 112 receive the biasing force of the spring 120 and rise in the vertical direction. Moreover, the cam 136 is rotated by half and is stopped, whereby the protrusion 117a of the rib 114 comes into contact with the nozzle surface 21a as shown in FIG. 12. That is, the cap frame 112 is situated in the sealing position. As a result, the nozzles Nz are sealed.

In addition, when the cap unit 110 is operated, the head unit 21 and the platen 34 are not moved. That is, the nozzles Nz are sealed only by the movement of the cap frame 112 facing the line head 21. For this reason, immediately after the image is printed on the paper S, the nozzles Nz are sealed.

Next, an operation example of the cap unit 110 upon discharging the ink onto the paper S from the sealing state of the nozzles Nz will be described.

In order to discharge the ink onto the paper S from the sealing state of the nozzles Nz, there is a necessity to move the cap frame 112 situated in the cap position to the retreated position. Moreover, in the present embodiment, the timing of moving the cap frame 112 to the retreated position is immediately before the paper S faces the line head 21. For example, when the upstream side transport roller 22 starts to transport the paper S, the cap frame 112 is moved to the retreated position.

The movement of the cap frame 112 to the retreated position is also executed by rotating the cam 136 by the driving of a driving portion 130. That is, the cam 136 is rotated, whereby the cam follower 138 and the cap frame 112 descend in the vertical direction to resist the biasing force of the spring 120. Moreover, the cam 136 is rotated by half and is stopped, whereby the cap frame 112 is situated in the retreated position. That is, the outer peripheral portion 117 of the rib 114 is situated in the lower part than the rib 35 of the platen 34. Moreover, in the state in which the cap frame is situated in the retreated position, ink is discharged to the paper S transported onto the platen 34.

In this manner, since the nozzles Nz are sealed immediately before discharging ink to the paper S, the drying of the nozzles Nz or the like can be effectively prevented. In addition, the detector 80 (FIG. 1) detects the position of the paper S on the transport path, whereby the movement of the cap frame 112 is controlled based on the position of the detected paper S.

Incidentally, in the present embodiment, when the nozzles Nz are sealed or unsealed by the cap unit 110, the platen 34 and the head unit 20 are not moved. For this reason, since the sealing and the unsealing of the nozzles Nz are rapidly performed, it is possible to effectively prevent the nozzles Nz from the dust or the drying. Furthermore, since the head unit 20 is not moved in the vertical direction but is fixed, the meniscus of the nozzles Nz can be uniformly maintained. Furthermore, since the head unit 20 is not moved in the vertical direction, the distance (gap) between the nozzle surface 21a and the platen 34 is constant. For this reason, the landing position of ink onto the paper S is constant, whereby it is possible to prevent the deterioration of image quality of the image to be printed on the paper S.

### 4. Operation Example of Cleaning Unit 160

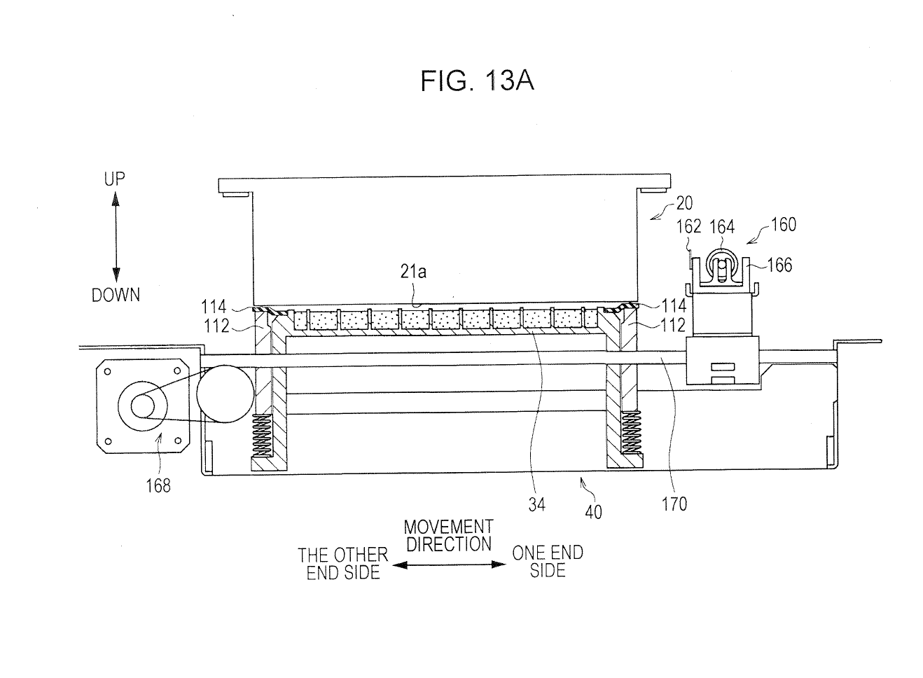

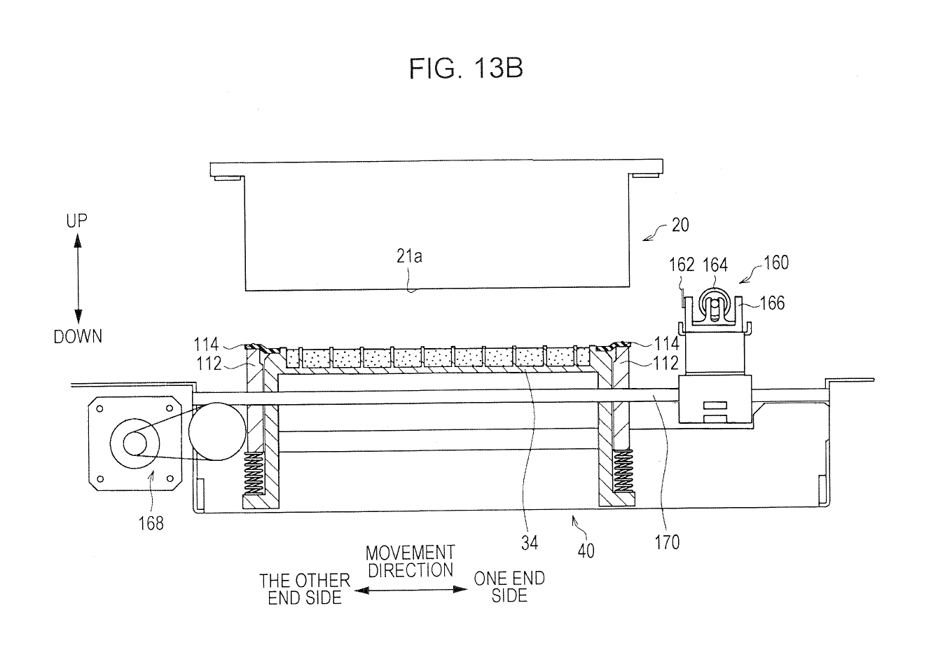

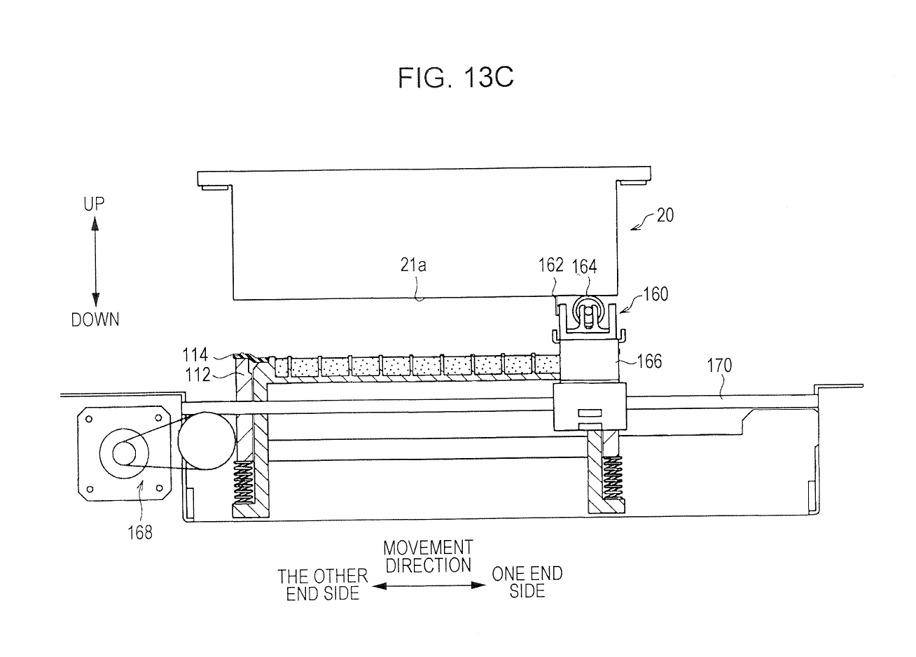

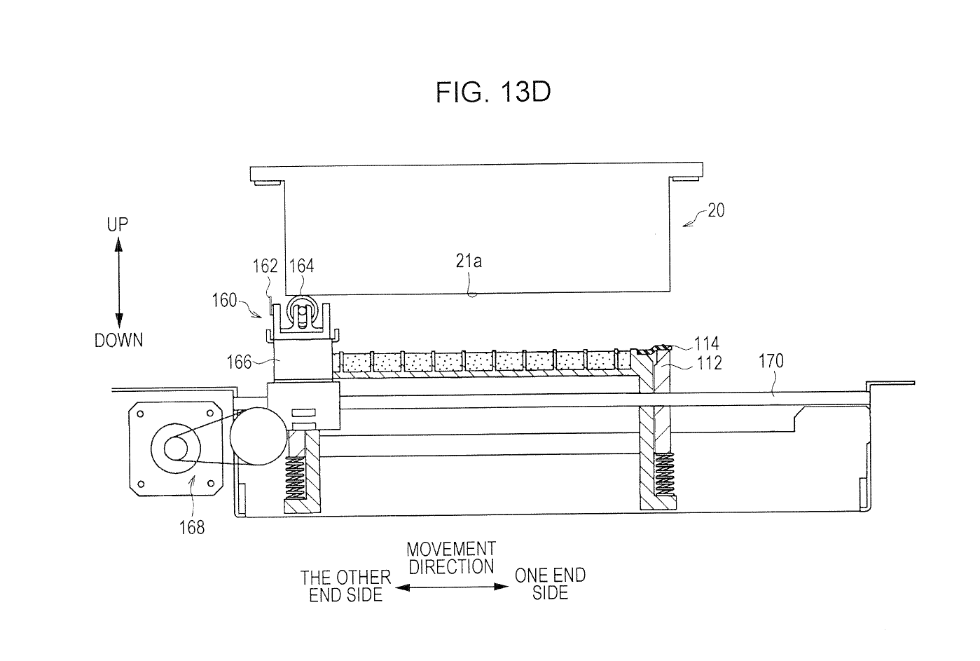

A cleaning operation of the nozzle surface 21a by the cleaning unit 160 will be described using FIGS. 13A to 13D. FIGS. 13A to 13D are diagrams for describing the cleaning of the nozzle surface 21a. FIG. 13A is a diagram that shows the state in which the nozzles Nz are sealed. FIG. 13B is a diagram that shows the state in which the maintenance unit 40 descends. FIG. 13C is a diagram that shows the starting state of the cleaning of the nozzle surface 21a. FIG. 13D is a diagram that shows the ending state of the cleaning of the nozzle surface 21a.

The cleaning operation according to the present embodiment is, for example, performed on the nozzle surface 21a of the line head 21 after performing the suction operation by the suction pump to the line head 21. The cleaning operation is executed by the controller 70.

In the following description, the cleaning operation is started from the state the shown in FIG. 13A, that is, from the state in which the rib 114 abuts against the nozzle surface 21a.

Firstly, from the state shown in FIG. 13A, the maintenance unit 40 descends in the vertical direction. That is, the maintenance unit 40 descends along a pair of shafts 172 (FIG. 4) due to a driving source (not shown). Moreover, the descended maintenance unit 40 is stopped in the cleaning position shown in FIG. 13B. As a result, a large space is formed between the platen 34 and the line head 21.

When the maintenance unit 40 is situated in the cleaning unit, the mover 166 of the cleaning unit 160 is moved to the space formed between the platen 34 and the line head 21. Specifically, the mover 166 is moved from one end side of the movement direction to the other side thereof along the shaft guide 170 by the driving portion 168. While the mover 166 is moved, the blade 162 and the wiper 164 abut against the nozzle surface 21a of the line head 21 as shown in FIG. 13C.

In the state in which the blade 162 and the wiper 164 abut against the nozzle surface 21a, the blade 166 is moved to the position shown in FIG. 13D, whereby the nozzle surface 21a is cleaned by the blade 162 and the wiper 164. That is, the dust or the thickening ink attached to the nozzle surface 21a is scraped by the blade 162, and the dust or the thickening ink attached to the nozzle surface 21a is wiped by the wiper 164.

After the mover 166 is stopped in the position shown in FIG. 13D, the mover 166 returns to the position shown in FIG. 13B, whereby the cleaning operation is finished. After that, the maintenance unit 40 ascends along the guide shaft, and the rib 114 seals the nozzles Nz.

In this manner, according to the present embodiment, when the rib 114 seals the nozzles Nz, even if the cleaning operation is executed, it is possible to greatly reduce the time when the rib 114 does not seal the nozzles Nz, and thus the states of the nozzles Nz can be suitably maintained.

### 5. Effectiveness of Printer According to the Present Embodiment

The effectiveness of the printer 10 according to the present embodiment will be described while comparing to a comparative example.

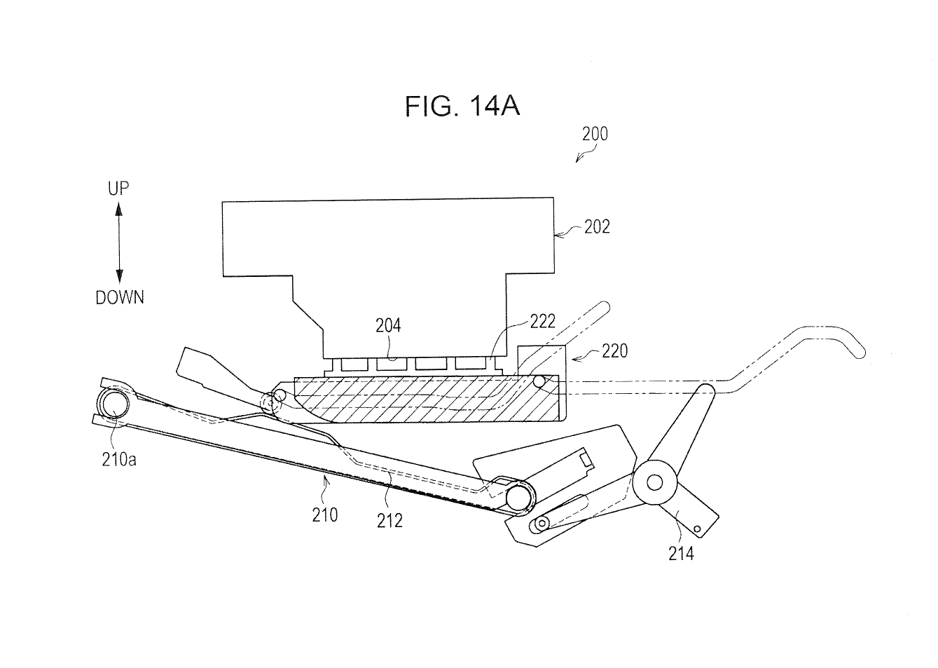

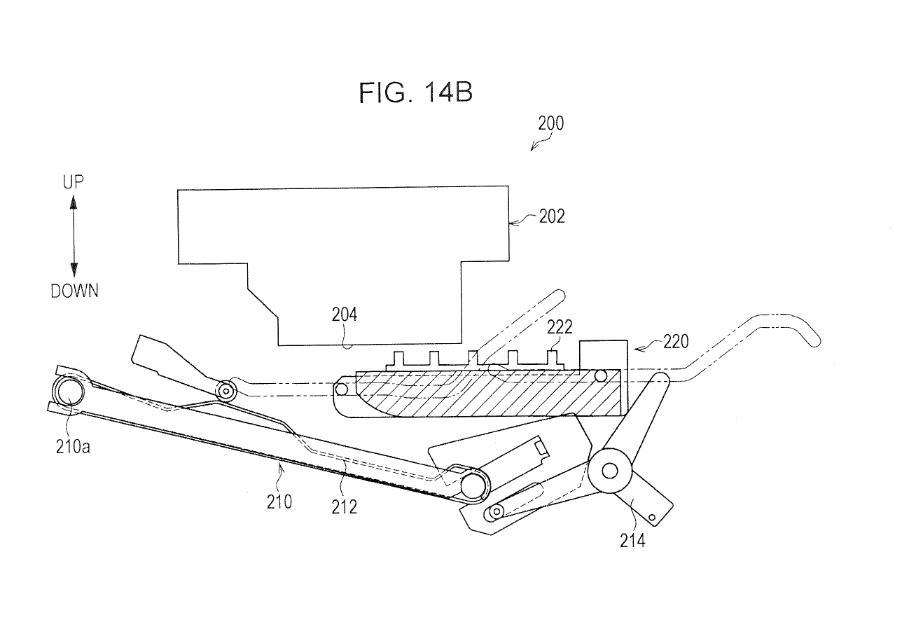

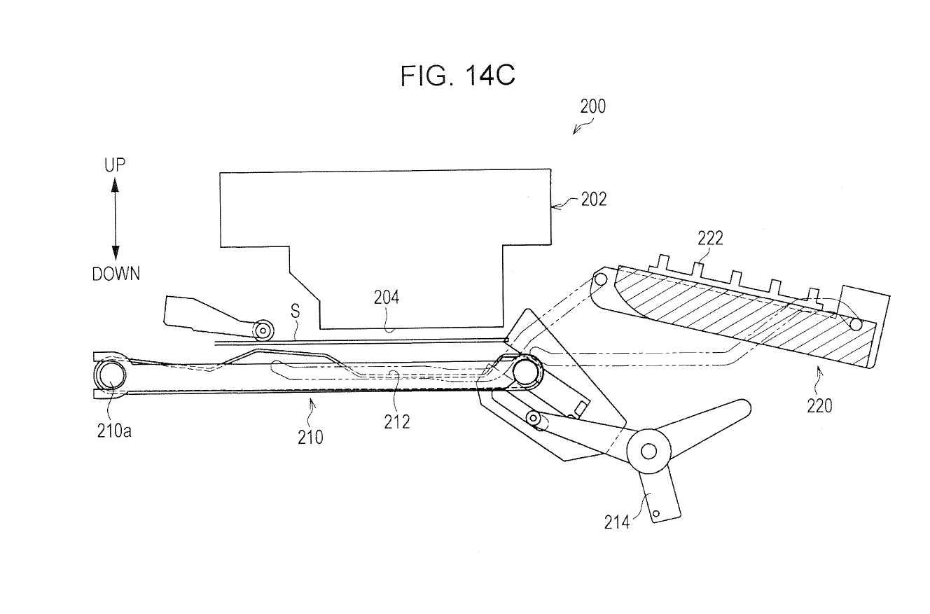

Firstly, a printer 200 according to comparative examples shown in FIGS. 14A to 14C will be described. FIG. 14A is a diagram that shows a standby state in which a cap member abuts against the nozzle surface. FIG. 14B is a diagram that shows the movement state of the transport portion and the cap unit. FIG. 14C is a diagram that shows a printing state in which the cap member is retreated.

In the comparative examples, when the transition from the standby state shown in FIG. 14A to the printing state shown in FIG. 14C is performed, a transport portion 210 including a platen 212, and a cap unit 220 including a cap member 222 are moved, respectively. That is, the cap unit 220 is slidably moved, and a lever 214 is rotated in connection with the slide movement, whereby the transport portion 210 is rotated around the rotation shaft 210a. Owing to such a configuration, there is a necessity for a region where the transport portion 210 and the cap unit 220 are moved, and the apparatus becomes larger. Furthermore, a mechanism, which moves the transport portion 210 and the cap unit 220, is complicated, and the number of the components is increased. Additionally, since the movement amount of moving the cap unit 220 is increased, for example, the transition time from the printing state to the standby state is enlarged, whereby the drying of the nozzles or the like is easily generated.

Contrary to this, in the printer 10 according to the present embodiment, in the state in which the head unit 20 and the platen 34 face each other, as shown in FIGS. 11 and 12, the nozzles can be sealed by the rib 114 by raising the cap blade 112. In this manner, since the movement of the transport unit 20 or the like is not generated in the present embodiment, the configuration of the printer 10 can be simplified as compared to the comparative examples.

Furthermore, in the present embodiment, since the cap frame 112 is simply moved along the side of the platen 34 vertically, the movement amount of the cap frame 112 is small, and there is no necessity to increase the surrounding space of the platen 34. For this reason, as compared to the comparative example, miniaturization of the printer 10 can be realized.

Moreover, in the present embodiment, the nozzles are sealed by the space surrounded by the platen 34 and the rib 114. That is, the platen 34 has the function of sealing the nozzles Nz as well as supporting the paper S during printing. This enables the platen 34 to be further effectively utilized as compared to the comparative example in which only the cap member 222 seals the nozzles Nz.

Furthermore, in the present embodiment, until the nozzles are unsealed to discharge the ink, the movement or the like of the transport unit 20 does not occur, and thus, the sealing state of the nozzles can be continued until the paper S reaches the head unit 20. Meanwhile, in the comparative example, since the transport portion 210 is moved along with the movement of the cap unit 220, the time from after the nozzles are unsealed to when ink is discharged is lengthened, and it is feared that a disadvantage such as drying of the nozzles may occur in the meantime.

In this manner, according to the printer 10 relating to the present embodiment, the nozzles Nz can be rapidly sealed using a simple configuration, and it is possible to reduce the time when the nozzles are opened from the unsealing of the nozzles to the ink discharging onto the paper S. As a consequence, the time of sealing the nozzles can be maximally secured, and thus, it is possible to further effectively protect the nozzles from the dust, the drying or the like. Similarly, even when executing the cleaning operation from the sealing state of the nozzles, the transition to the cleaning operation can be quickly performed.

### 6. Other Embodiments

As mentioned above, the preferred embodiments of the present disclosure were described in detail with reference to the drawings, but the present disclosure is not limited to the embodiments. It is evident that a person having ordinary knowledge in the field of technology to which the present disclosure belongs can contemplate various changes and modifications within scope of technical idea described in the claims, and it is understood that they also fall within the technical scope of the present disclosure.

Furthermore, in the embodiment mentioned above, although the ink jet printer as the liquid discharging apparatus was described, the present disclosure is not limited thereto. For example, the same technology as the present disclosure may be applied to various liquid discharging devices which apply an ink jet technology such as a color filter manufacturing device, a dyeing device, a micromachining device, a semiconductor manufacturing device, a surface machining device, a three-dimensional molding machine, an organic EL manufacturing device, and a display manufacturing device.

Furthermore, although, as the energy generating element, the heating resistor was described as an example in the embodiment mentioned above, the present disclosure is not limited thereto. For example, as the energy generating element, it is also possible to use a heating element other than the heating resistor (heater or the like) or a piezoelectric element such as a piezo element.

Furthermore, although, as the liquid discharging head, the line head 21 was described as an example in the embodiment mentioned above, the present disclosure is not limited thereto. For example, the present disclosure may be applied to a so-called serial type printer which discharges the ink while moving the printer head on the medium in a specific direction.

Moreover, although it was described that the protrusion 117a of the rib 114 abuts (line-contact) against the nozzle surface 21a in the embodiment mentioned above, the present disclosure is not limited thereto. For example, the outer peripheral portion 117 of the rib 114 may come into surface-contact with the nozzle surface 21a.

Furthermore, although it was described that the rib 114 collectively seals the plurality of color nozzles in the embodiment mentioned above, the present disclosure is not limited thereto. For example, ribs may be provided for each color of ink.

The present disclosure contains subject matter related to that disclosed in Japanese Priority Patent Application JP 2010-188555 filed in the Japan Patent Office on Aug. 25, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid discharging apparatus comprising:
a liquid discharging head that has a nozzle surface formed with nozzles discharging liquid;
a support member that is provided in a position facing the nozzle surface and supports a medium on which liquid discharged from the nozzles is landed;
a frame that is movable along a side of the support member in the state of surrounding the side of the support member; and
a sealing member that is supported by the frame and seals the nozzles upon coming into contact with the nozzle surface along with the movement of the frame.

2. The liquid discharging apparatus according to claim 1,
wherein a planar shape of the sealing member may be a rectangular shape that is formed with a through hole in the center thereof,
an inner peripheral portion of a center side of the sealing member is supported by the support member, and an outer peripheral portion of an outer periphery side of the sealing member is supported by the frame, and
the sealing member seals the nozzles together with the support member when coming into contact with the nozzle surface.

3. The liquid discharging apparatus according to claim 2,
wherein the outer peripheral portion of the sealing member is moved along with the movement of the frame, and
the outer periphery portion comes into contact with the nozzle surface when the sealing member is situated in the contact position, whereby the sealing member seals the nozzles.

4. The liquid discharging apparatus according to claim 3,
wherein the sealing member includes a bent portion that has flexibility and connects the inner peripheral portion with the outer peripheral portion, and
the outer peripheral portion is moved along with the movement of the frame, while the bent portion is deformed.

5. The liquid discharging apparatus according to claim 1,
wherein the sealing member has a protrusion that comes into contact with the nozzle surface upon being situated in the contact position and the protrusion seals the nozzles by coming into contact with the nozzle surface.

6. The liquid discharging apparatus according to claim 1,
wherein the liquid discharging head is fixedly supported so as not to be movable to an apparatus main body.
